(19) United States
(12) Patent Application Publication
(10) Pub. No.: US 2026/0081127 A1
(43) Pub. Date: Mar. 19, 2026

(54) Systems and Methods for Increased MRM Capacity

(71) Applicant: DH Technologies Development Pte. Ltd., Singapore (SG)

(72) Inventor: David Michael COX, Toronto (CA)

(73) Assignee: DH Technologies Development Pte. Ltd., Singapore (SG)

(21) Appl. No.: 19/125,493

(22) PCT Filed: Oct. 27, 2023
(86) PCT No.: PCT/IB2023/060857

§ 371 Date: Apr. 29, 2025

Related U.S. Application Data
(60) Provisional application No. 63/421,204, filed on Nov. 1, 2022.

(51) Int. Cl. H01J 49/00

(52) U.S. Cl. CPC H01J 49/0036; H01J 49/005

(57) ABSTRACT

A mass spectrometry system comprises a detector configured to detect a plurality of signals corresponding to a plurality of compounds in a sample; and an analyzer module configured to receiving, from the detector, signal data corresponding to the plurality of signals; performing an analysis of a signal of the plurality of signals corresponding to a compound of the plurality of compounds to detect an onset of an increase in the signal, wherein the analysis is different from comparing an intensity of the signal with a threshold; and increasing a dwell time for the compound in response to detecting the onset. In some embodiments, the analyzer module is further configured to determine an onset probability as the probability of occurrence for the onset; and utilize the onset probability in detecting the onset.

### RELATED APPLICATIONS

This application claims priority to U.S. Provisional Application No. 63/421,204 filed on Nov. 1, 2022, the contents of which are incorporated herein in their entirety.

### TECHNICAL FIELD

The present disclosure relates generally to mass spectrometers and more specifically for optimizing the number and quality of detected compounds in mass spectrometry.

### BACKGROUND

Many technologies or industries, such as the pharmaceutical industry, utilize mass spectrometry for identifying or quantifying compounds of interest in a sample. One type of widely used mass spectrometry technology is the multiple reaction monitoring (MRM) technology. Detecting many hundreds of compounds via mass spectrometry such as MRM, however, may be challenging. As more compounds are monitored, the dwell time (which is the time spent measuring ions from a compound) may be required to decrease to maintain a good cycle time (which is the time between measurement points) while fitting a minimum number of cycles within the operation time of the mass spectrometer. The minimum number of cycles may be required because the number of cycles may determine the number of points across an eluting compound peak from a compound source such as liquid chromatography (LC). As dwell time gets too small, however, the variability of the measurement of ions may increase, making it difficult, or impossible, to reliably detect low abundant compounds. In addition, there may be a small pause time between consecutive detections of two compounds. Such a pause time may be utilized to prevent crosstalk, where detection of ions from one compound may be incorrectly assigned to the next compound being measured. The required inclusion of pause times may further limit the number of compounds being monitored within a desired cycle time.

Therefore, scheduling the dwell times within the cycles remain a challenge for optimizing the number of analyzed compounds while maintaining the quality and reliability of the measurements or detections.

### SUMMARY

In some embodiments, the techniques described herein relate to a method for analyzing a sample by mass spectrometry, the method including: detecting a plurality of signals corresponding to a plurality of compounds in the sample; performing an analysis of a signal of the plurality of signals corresponding to a compound of the plurality of compounds to detect an onset of an increase in the signal, wherein the analysis is different from comparing an intensity of the signal with a threshold; and in response to detecting the onset, increasing a dwell time for the compound.

In some embodiments, the techniques described herein relate to a method, further including subtracting a background signal from the signal before performing the analysis.

In some embodiments, the techniques described herein relate to a method, wherein detecting the onset includes detecting a rate of change of the signal corresponding to the compound.

In some embodiments, the techniques described herein relate to a method, further including increasing a pause time corresponding to the compound in response to detecting the onset.

In some embodiments, the techniques described herein relate to a method, further including setting the pause time to zero before detecting the onset.

In some embodiments, the techniques described herein relate to a method, wherein in response to detecting the onset, the dwell time for the compound is increased to a data collection value for collection of data corresponding to one or more fragments of the compound.

In some embodiments, the techniques described herein relate to a method, further including, before detecting the onset, setting the dwell time for the compound to a low value that is lower than the data collection value, wherein the low value enables generating the signal corresponding to the compound.

In some embodiments, the techniques described herein relate to a method, further including determining an onset probability as the probability of occurrence for the onset; and utilizing the onset probability in detecting the onset.

In some embodiments, the techniques described herein relate to a method, wherein determining the onset probability utilizes information about a retention time for the compound.

In some embodiments, the techniques described herein relate to a method, wherein: the compound is a first compound; and determining the onset probability utilizes information about detecting a second compound that is related to the first compound.

In some embodiments, the techniques described herein relate to a method, further including increasing the dwell time if the onset probability exceeds a threshold probability.

In some embodiments, the techniques described herein relate to a method, further including decreasing the dwell time if the onset probability is below a threshold probability.

In some embodiments, the techniques described herein relate to a method, wherein decreasing the dwell time includes setting the dwell time to a zero value.

In some embodiments, the techniques described herein relate to a method, further including dividing a cycle time into a plurality of dwell times for a plurality of compounds proportional to a plurality of onset probabilities for the plurality of compounds.

In some embodiments, the techniques described herein relate to a method, further including detecting a decrease in the signal; and in response to detecting the decrease in the signal, decreasing the dwell time for the compound.

In some embodiments, the techniques described herein relate to a method, wherein decreasing the dwell time includes setting the dwell time to a zero value.

In some embodiments, the techniques described herein relate to a method for analyzing a sample by mass spectrometry, the method including: detecting a plurality of signals corresponding to a plurality of compounds in the sample; performing an analysis of a signal of the plurality of signals corresponding to a compound of the plurality of compounds to detect an onset of an increase in the signal, wherein the analysis does not include comparing an intensity of the signal with a threshold; and in response to detecting the onset, increasing a dwell time for the compound.

In some embodiments, the techniques described herein relate to a method for analyzing a sample by mass spectrometry, the method including: detecting a plurality of signals corresponding to a plurality of compounds in the sample; performing an analysis of a signal of the plurality of signals corresponding to a compound of the plurality of compounds to detect an onset of an increase in the signal; and in response to detecting the onset, increasing a pause time corresponding to the compound.

In some embodiments, the techniques described herein relate to a method for analyzing a sample by mass spectrometry, the method including: detecting a plurality of signals corresponding to a plurality of compounds in the sample; performing an analysis of a signal of the plurality of signals corresponding to a compound of the plurality of compounds to detect an onset of an increase in the signal, wherein the analysis includes at least one of: detecting a rate of change of the signal, and utilizing probability of occurrence of the onset; and in response to detecting the onset, increasing a dwell time for the compound.

In some embodiments, the techniques described herein relate to a mass spectrometry system including: a detector configured to detect a plurality of signals corresponding to a plurality of compounds in a sample; and an analyzer module configured to: receiving, from the detector, signal data corresponding to the plurality of signals; performing an analysis of a signal of the plurality of signals corresponding to a compound of the plurality of compounds to detect an onset of an increase in the signal, wherein the analysis is different from comparing an intensity of the signal with a threshold; and increasing a dwell time for the compound in response to detecting the onset.

In some embodiments, the techniques described herein relate to a system, wherein the analyzer module is further configured to: determine an onset probability as the probability of occurrence for the onset; and utilize the onset probability in detecting the onset.

In some embodiments, the techniques described herein relate to a system, wherein the analyzer module is further configured to determine the onset probability by utilizing information about a retention time for the compound.

In some embodiments, the techniques described herein relate to a system, wherein: the compound is a first compound; and the analyzer module is further configured to determine the onset probability by utilizing information about detecting a second compound that is related to the first compound.

In some embodiments, the techniques described herein relate to a system, wherein the analyzer module is configured to increase the dwell time if the onset probability exceeds a threshold probability.

In some embodiments, the techniques described herein relate to a system, wherein the analyzer module is further configured to decrease the dwell time if the onset probability is below a threshold probability.

In some embodiments, the techniques described herein relate to a system, wherein the analyzer module is further configured to divide a cycle time into a plurality of dwell times for a plurality of compounds proportional to a plurality of onset probabilities for the plurality of compounds.

Further understanding of various aspects of the embodiments may be obtained by reference to the following detailed description in conjunction with the associated drawings, which are described briefly below.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

In the drawings:

FIG. 1 is a block diagram of a mass spectrometry system 100 according to some embodiments.

FIGS. 2A and 2B illustrate two examples of signal peaks according to some embodiments.

FIG. 3 shows a flow chart of an onset detection method 300 according to some embodiments.

FIG. 4 shows a flow chart for an onset detection method 400 that includes utilizing the onset probabilities according to some embodiments.

FIG. 5 schematically depicts an example of an implementation of a module 500 according to some embodiments.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

Some embodiments may address the challenges of the scheduling the dwell times by using known elution retention times for the compounds being monitored. This technique may reduce the number of concurrent MRM being measured, thus improving dwell time and maintaining good cycle time. However, obtaining, and maintaining the retention times for a large list of compounds, on a particular LC system, may be very difficult. Moreover, determining some retention times may be impossible or the result may be inaccurate. Some of the compounds may have no suitable standard. Trying to mix hundreds of compounds to make a single solution containing all standards may be impossible, as some compounds will cause others to degrade, or prevent them from being ionized during mass spectrometric detection. Some embodiments, therefore, may enable scheduling the dwell times with techniques that include methods other than, or in addition to, using the retention times.

In some embodiments, when screening for hundreds of compounds, only a small number of compounds may have a signal intensity higher than the baseline at any given time. The baseline intensity may be defined as the minimum intensity required for collecting reliable data. Therefore, the dwell time can be set very small for a compound, while it is not eluting.

Some embodiments utilize the detection of signals that indicate the onset of the allusion of a compound and accordingly increasing the dwell times for those compounds. When the beginning of a peak is detected (which may include detecting an intensity above a threshold, dynamic background subtract intensity above a threshold, or other peak detection means), then the dwell time may be increased to a level more suitable for obtaining reliable data and good peak integration. Additionally, the pause time may be set very small, or to zero, for a compound, while it is not eluting.

In some embodiments, when a compound signal is detected, the corresponding compound may not be determined definitively, because more than one compound may generate the same signal. Including multiple MRM for the same compound (which may include detecting multiple fragments of that compound) may increase the confidence in determining if a compound is present, but the number of such candidates per compound may be limited. Therefore, the dwell time for those limited candidates may be increased such that the actual compound may be determined.

In various embodiments, operations, such as detection or analysis, that relate to a fragment of a compound may interchangeably be attributed to the compound. For example, detection of a signal that corresponds to a fragment of a compound may be termed as detection of a signal that corresponds to the compound. Similarly, the dwell times that correspond to the detection of one or more fragments of a compound, or the detection of their onsets, may collectively be termed as the dwell time for the detection of the compound or their onsets.

Further description of the systems and methods used for optimum determination of the dwell times and operation of the mass spectrometry system comes below.

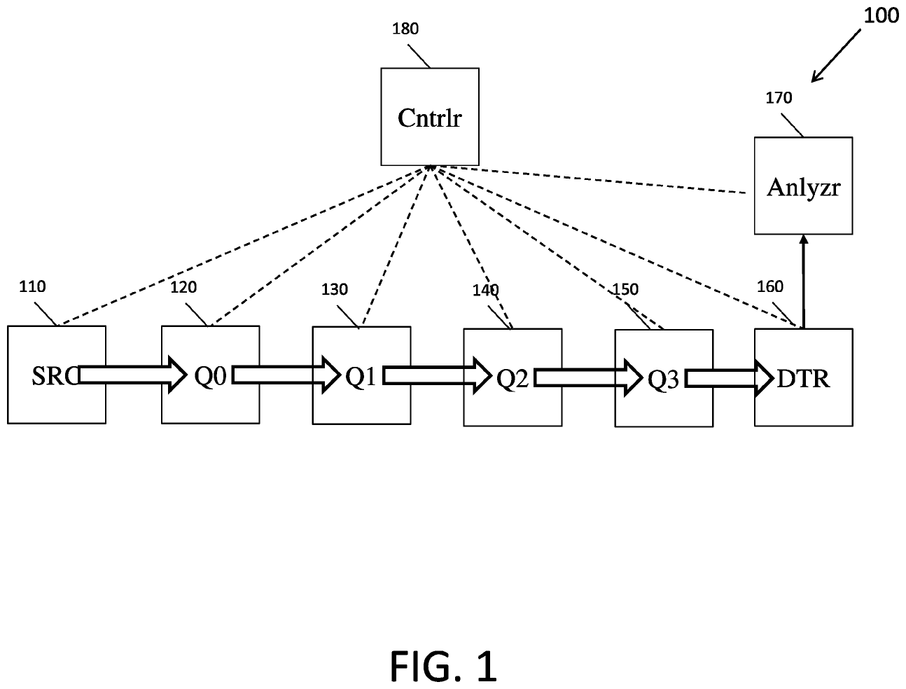

FIG. 1 is a block diagram of a mass spectrometry system 100 according to some embodiments. System 100 comprises parts that include an ion source 110, a cooling chamber 120, a precursor ion selection chamber 130, a collision chamber 140, a fragment selection chamber 150, a detector 160, an analyzer module 170, and a controller module 180. In various embodiments, one or more of the parts in system 100 may exchange data, particles, or ions in the manner described below.

Ion source 110 ionizes one or more compounds that are being analyzed and sends the generated ions to cooling chamber 120. In various embodiments, ion source 110 may include an electrospray ion source, a thermospray ion source, an atmospheric pressure chemical ionization (APCI) ion source, etc.

Cooling chamber 120 may reduce the kinetic energy of one or more sets of the received ions or may generate a focused beam of one or more sets of the ions. Cooling chamber 120 may also send the focused beam into precursor ion selection chamber 130.

Chamber 130 may include electrical or magnetic fields that can be tuned to select one or more precursor ions for transmission into collision chamber 140. For example, the tuning may be such that precursor ions with one or more specific values of mass to charge ratio (m/z) are selected and sent to collision chamber 140.

Collision chamber 140 provides an environment in which the received precursor ions collide with gas molecules in chamber 140 and fragment. The fragments of the precursor ion generated in this way may then be sent into fragment selection chamber 150.

Chamber 150 may also include electrical or magnetic fields that can be tuned such that one or more types of specific fragments (based on, for example, their m/z value) are selected and sent into detector 160.

Detector 160, in turn, is configured to detect the received fragments and measure their number or intensity. Detector 160 may, for example, generate for each received fragment a number of electrons and detect the electrical signal that those electrons generate. The intensity of the signal, therefore, may be proportional to the number of received fragments.

Analyzer module 170 may receive from detector 160 various types of data including intensities and times of occurrence for each signal. Analyzer module 170 may use the received data to determine the m/z of the fragments corresponding to each signal and map those values to the intensity of the corresponding signal. Analyzer module 170 may also convert the electrical intensity of each signal to a corresponding intensity of the detected fragments measured, for example, in counts per second (cps).

Controller module 180 may communicate with one or more of the parts 110-170 and control the operation of system 100. In particular, controller module 180 may receive data from analyzer module 170 and, in response, set or change the settings of precursor ion selection chamber 130 or fragment selection chamber 150 in the manner described below for detecting different fragments of different precursor ions (hereinafter called fragment detection settings).

System 100 may determine the relative number of different fragments that are generated from a selected precursor ion based on the relative intensity of the signals that are generated by those fragments. Those relative numbers, together with the information about m/z of the selected precursor ion and each of the fragments, may enable analyzing the compound and, for example, determining its composition or structure.

Therefore, during a time interval of its operation, controller module 180 may target specific fragments of specific precursor ions by tuning one or more parts of the system for detecting those parts. The tuning for detecting a specific fragment of a specific precursor ion may, for example, respectively depend on the tuning of fragment selection chamber 150 and the tuning of precursor ion selection chamber 130. Because different tunings may be required to detect different precursor ions or different fragments, during each such time interval the system may be able to detect one specific precursor ion/fragment combination (an individual MRM transition). The time interval during which the system is tuned for detecting a specific fragment may be called the dwell time for that fragment. In various embodiments the dwell time may have different values in a range from a few milliseconds to tens of milliseconds. For example, the dwell time may be 1 ms, 2 ms, 5 ms, 10 ms, 20 ms, 30 ms, 50 ms, etc.

In some embodiments, for each precursor ion, the controller targets one fragment of that precursor ion and accordingly determines the relative abundance of the precursor ion based on the relative abundance of the fragment. Moreover, the controller may target additional fragments of the same precursor ion for confirmation that the correct precursor ion is being identified.

System 100, therefore, may be tuned during consecutive dwell times for detecting different fragments. In some embodiments, controller module 180 may span a sequence of dwell times (hereinafter also called the set of dwell times in a cycle) for detecting a set of fragments and then cycle back to detecting the first fragment in the set. The combination of the consecutive set of dwell times dedicated to detecting the set of different fragments before circling back to the first fragment may be called a cycle. In some embodiments, after completion of a cycle, controller module 180 may circle back to detecting not the first fragment in the set but another fragment in the set already detected or a fragment that was not included in the set, thus changing the set of targeted fragments for the new cycle. The total time dedicated to a cycle may be called a cycle time.

In some embodiments, the cycle may also include a set of pauses each occurring between a pair of consecutive dwell times. During each pause time, controller module 180 may halt operation of one or more of ion source 110, precursor ion selection chamber 130, fragment selection chamber 150, and detector 160. More generally, during a pause time, the controller may halt the generation or detection of fragments, to allow the fragments that were generated during the latest dwell time to clear the system. During each pause time, different parts of the system may also be prepared or tuned for detecting the fragments that will be targeted in the next dwell time. Therefore, a cycle may be the combination of consecutive dwell times each followed by a pause time, and a cycle time may be calculated as the sum of the dwell times and the pause times included in the cycle. In various embodiments the pause time may have different values in a range from a few milliseconds to tens of milliseconds. For example, the pause time may be 1 ms, 2 ms, 5 ms, 10 ms, 20 ms, 30 ms, 50 ms, etc.

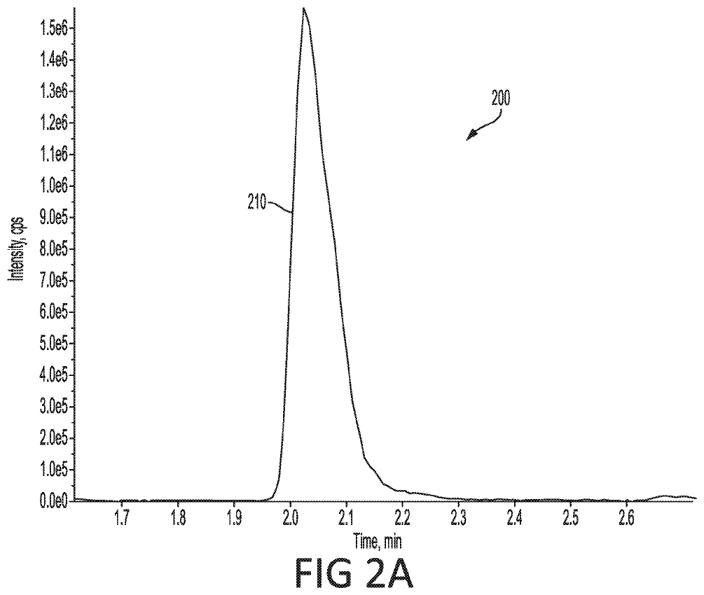

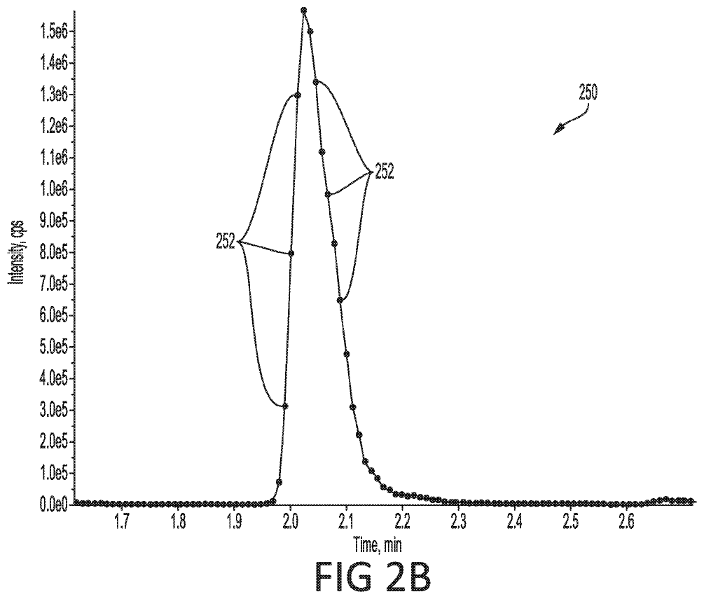

During its operation, analyzer module 170 may generate one or more signal peaks corresponding to one or more detected fragments. FIGS. 2A and 2B illustrate two examples of signal peaks according to some embodiments. In particular, FIG. 2A is a section of an exemplary spectrometry intensity diagram 200 according to an embodiment. Diagram 200 includes a signal peak 210, which reflects the intensity of the signal as a function of the time of detection. More specifically, in diagram 200, the X axis indicates time in minutes and the Y axis indicates intensity in counts per second (cps). Therefore, signal peak 210 indicates that the corresponding fragments were detected in a time interval located between 5 minutes and 6 minutes, and their intensity reached a maximum around 6×104 cps.

In some embodiments, analyzer module 170 collects data and generates a signal peak during multiple cycles. In particular, during each cycle, analyzer module 170 may collect the signal intensity for a specific fragment and accordingly determine one of the points of the corresponding signal peak. In this way, after multiple cycles, analyzer module 170 may collect multiple points of the signal peak and based on those points produce the shape and location of the complete peak. FIG. 2B schematically shows such a signal peak 250 generated by an analyzer module according to some embodiments. More specifically, signal peak 250 includes 9 signal points 252. The analyzer module may collect the data for each signal point 252 during a corresponding dwell time in one cycle. Therefore, the 9 signal points 252 in signal peak 250 may result from data collection during nine different cycles.

In some embodiments, in order to generate a reliable graph of a signal peak, the analyzer module may require generating a number of signal points that exceeds a minimum number. The minimum number of required signal points may be a number between 3 and 20, for example, 7, 12, or 15. If the number of signal points is less than the minimum required number, it may not be possible to generate a reliable signal peak that reflects the relative abundance of the corresponding fragment within the required accuracy. Therefore, the controller module may be required to allocate a minimum number of cycles for generating and collecting signals for each targeted fragment.

Moreover, within each cycle, the controller module may be required to determine the fragments to be targeted in the cycle and allocate a dwell time in the cycle to each of those targeted fragments. In order to ensure collecting reliable data for each targeted fragment, the controller may be required to allocate a dwell time that exceeds a minimum required dwell time for that fragment. The minimum required dwell time for a fragment may be defined as the minimum time required to collect reliable data for the fragment. If the analyzer module allocates to a targeted fragment a dwell time that is less than the minimum required dwell time for that fragment, the resulting data may not be reliable because of having a high margin of error due to dominance of noise. The minimum required dwell time for a fragment may depend on performance characteristics of the system, such as the speed of the transition of the ions through the system before reaching the detector. For example, a higher speed may require a lower dwell time. Moreover, less abundant compounds may require a longer dwell time for the system to detect a strong enough signal. The dwell times for different fragments may be the same or different, and may have values in the range 1 ms-500 ms. The minimum required dwell time for a fragment may be, for example, 2 ms, 20 ms, 30 ms, 50 ms, etc. A dwell time that is not less than the minimum required dwell time may be called a data collection dwell time, indicating that its length is suitable for collecting reliable data for a signal point for the corresponding fragment.

On the other hand, regarding a maximum value for a dwell time corresponding to a fragment, ideally the controller module would allocate a long dwell time to all the targeted fragments in all cycles. But such ideal allocation of dwell times may not be possible due to multiple limitations. Those limitations include the limited time during which the ion source may generate the corresponding precursor ion (hereinafter called the retention time for that precursor ion). More specifically, the ion source may generate different precursor ions during different retention times. The length of the retention time peak width for different precursor ions may be the same or may vary from around, for example, a few 100 milliseconds to a few seconds, e.g., 2, 5, 10, 15 seconds, etc. Moreover, the retention times for different precursor ions may be at different levels of overlap. For example, two retention times for two different precursor ions may fully overlap, one of them may include the other, may be separate with some overlap, or may be separate with no overlap.

For each precursor ion, the controller module may be required to schedule all the dwell times for the one or more targeted fragments corresponding to that precursor ion during the retention time of the precursor ion Therefore, the controller module may be required to allocate an optimum number of cycles and, within each cycle, an optimum number of dwell times with an optimum length allocated to each. Those optimum values may be determined based on the conditions and limitations described above. For example, the analyzer module may be required to divide the total operation time into a number of cycles such that each cycle collects data for a number of targeted fragments, and further, for each targeted fragment, a sufficient number of signal points are generated during multiple cycles. The controller module may determine the fragments that are targeted during each cycle based on information indicating that the cycle includes the retention time for the corresponding precursor ion.

In some embodiments, the controller module may allocate a data collection dwell time to targeted fragment based on detection of a high signal for the fragment during the previous cycle. Further, in some embodiments, the dwell time for a fragment may be inversely proportional to the abundance of the corresponding compound. That is, a higher abundance for a compound may indicate that a smaller dwell time is required for generating and detecting a strong signal and reliable data for the corresponding fragment.

Therefore, the controller module may be required to optimize the timing of the dwell times for each fragment such that they fall inside the retention time peak width for the corresponding precursor ion. Moreover, the controller module should optimize the length of the dwell times for each targeted fragment such that each dwell time may exceed the corresponding minimum required dwell time and, at the same time, the dwell times can fit within the cycle times and satisfy the above-discussed constraints.

In order to optimize the allocation of dwell times (that is, the allocation of the time of occurrence and of the duration of the dwell time) in the manner discussed above, some embodiments may rely on predicting the timing (that is, the start time and the duration) of the retention time for the corresponding precursor ion. In some embodiments, the timing of the retention times for one or more of the precursor ions may be predicted using theoretical or empirical methods. The empirical methods may include the results of previous runs using the same or similar ion source. In many systems, however, challenges arise because the predictions for one or more of the retention times may be inaccurate or even impossible. For example, a specific retention time may be different for two similar ion sources or even the same ion source at two different times due to differences in structure, material, or environmental factors. For example, in systems that use liquid chromatography (LC) the retention time may change with the change of the length or volume of tubing in the LC, or connecting to or within the ion source, change of temperature, or some other characteristics of the LC column.

In the absence of, or in addition to, the above-discussed prediction of the timing of the retention times, some embodiments rely on detecting an onset of a signal corresponding to a targeted fragment (hereinafter called target onset for brevity). More specifically, during some cycles, the controller may determine whether a targeted fragment can be generated in the collision chamber by determining whether the corresponding signal is starting or has already started. Such a determination may indicate that the signal may be sufficiently strong in the subsequent cycles. A sufficiently strong signal may be a signal with an intensity that is above the baseline intensity. Alternatively, a weak signal may be a signal with an intensity that is at or below baseline intensity. In various embodiments, the baseline intensity may correspond to the background signal intensity that may be observed when the compound of interest is not being generated. Such a background signal intensity may be caused, for example, other ions or compounds that are present in the solvent used by the ion source, or in the environment such as the air. The background signal may also correspond to the electrical noise or other types of noise generated within the instruments of the detector.

In some embodiments, the target onset may happen during the retention time of the precursor ion for the targeted fragment. After detecting the target onset, the controller may allocate data collection dwell times to the targeted fragment, in one or more of the subsequent cycles. Doing so enables the analyzer module to collect reliable data for the targeted fragment.

Therefore, for allocating data collection dwell time to a targeted fragment, some embodiments employ techniques for detecting the target onset for the targeted fragment.

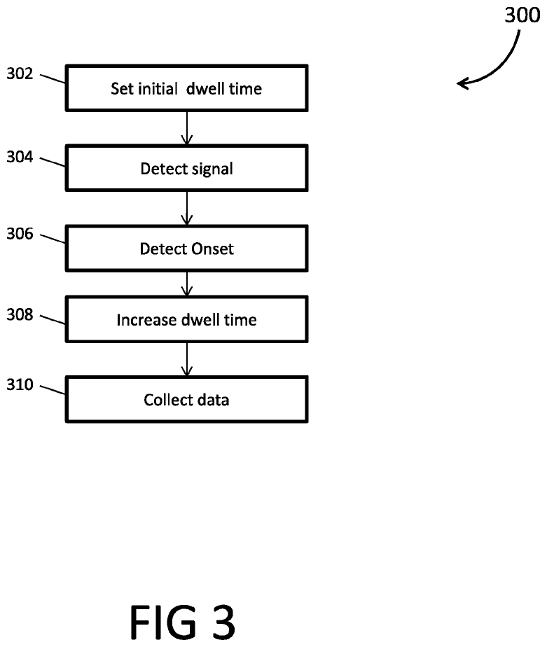

FIG. 3 shows a flow chart of one such onset detection method 300 according to some embodiments. Method 300 may be performed by a controller module during one or more cycles of data collection operation in a spectrometer.

At step 302 of method 300, before starting a cycle, the controller may determine a set of targeted fragments and, for each targeted fragment, set an initial dwell time. The set of targeted fragments may be determined based on different criteria. For example, the set of targeted fragments may include all fragments that are going to be targeted during the operation or a subset of those fragments. The subset, for example, may include those fragments for which there is a higher probability of generation during that cycle. Moreover, some other parameters may also determine whether or not a fragment should be included in the subset of targeted fragments. Those parameters may include, for example, the importance or sensitivity of detecting the targeted fragments.

The initial dwell times for the set of targeted fragments may also be determined based on different conditions or in different ways. For example, the initial dwell times may be equal for all targeted fragments. Alternatively, or in addition, the initial dwell time for one or more of the fragments may be equal or larger than the minimum required dwell time for those fragments.

Moreover, the initial dwell time for one or more of the targeted fragments of the cycle may be set to a low value, that is, a value lower than the minimum required dwell time for those fragments required for detection and quantitation. In some embodiments, this low value for the dwell time of a targeted fragment may at the same time be sufficient for detecting the onset for that fragment. In some embodiments, such low values may be called an onset detection value for the dwell time. In some embodiments, the onset detection value may be between 1 ms and 10 ms. Moreover, the onset detection value for a fragment may be lower than the minimum required dwell time for that fragment.

Returning to method 300 of FIG. 3, at step 304 the system operates for a cycle and detects signals for the set of targeted fragments for the cycle. More specifically, the controller module operates the system based on the initial dwell times and the detector detects the signals for each of the targeted fragments during the dwell time for that fragment.

At step 306, upon analyzing the signals, the analyzer module may detect the onset for one or more members of the set of targeted fragments. The analyzer module may detect the onset based on one or more conditions further detailed below.

At step 308, the controller module may increase the one or more dwell times for the targeted fragments for which the onset was detected. Those dwell times may be increased to a value that is equal or greater than the data collection dwell time. Doing so will enable the system to collect reliable data for the targeted fragment during the next cycle.

At step 310, the controller module operates the system for the next cycle time that is partitioned based on the revised dwell times. Accordingly, the analyzer module may collect data for the targeted fragments for which the onset was detected before.

In some embodiments, the analyzer module may further determine the probabilities for the onset of one or more of the fragments. An onset probability for a fragment may be a real number between 0 and 1 indicating the probability for the onset of the targeted fragment to occur within a cycle. The analyzer module may determine or change (increase or decrease) the onset probability for a targeted fragment based on one or more factors, as detailed below.

In some embodiments, when a cycle overlaps with an estimated retention time for a precursor ion, the analyzer module may increase the onset probability for one or more fragments of that precursor ion. Conversely, when a cycle is outside the estimated retention time for a precursor ion, the analyzer module may decrease the onset probability for a fragment of that precursor ion.

Further, in some embodiments, when a signal is detected for a first fragment corresponding to a first precursor ion that is generally created along with a second precursor ion, the analyzer module may increase the onset probability for a second fragment corresponding to the second precursor ion.

Moreover, in some embodiments, the analyzer module may increase the onset probability for a fragment when the analyzer detects that the corresponding signal is increasing with time. This detection may be derived by comparing the magnitudes of the detected signal for the fragment in the present cycle with the detected signal for the same fragment in one of the previous cycles. In some embodiments, the analyzer module may divide the difference between the magnitudes of the two detections by the time difference between the two detections to derive the derivative of the magnitude as a function of time.

Also, in some embodiments, during some cycles the system may be operated with one or more dwell times that are below the minimum required dwell time, one or more zero pause times, or may start a new MRM before completely clearing out the system from the fragments of the previous MRM. In such cases, the analyzer module may not be able to clearly assign a detected signal to a fragment associated to a specific MRM and instead increase the probability for multiple fragments associated to multiple MRMs, for example, two consecutive MRMs, during which the signal was detected.

Further, in some embodiments, if the analyzer detects multiple weak signals corresponding to multiple fragments that cannot be generated together, the analyzer module may increase the onset probability for one or more of those fragments. Increasing the onset probability may result in increasing the dwell times for those fragments during one or more of the subsequent cycles, therefore may result in increasing the signal and more accurately detecting the one or more fragments that generated the earlier weak signals.

In some embodiments, the onset probability for one or more of the fragments may be binary. A binary probability may, for example, have only two values of 0 and 1. For such fragments, the onset probability of 0 or 1 may respectively indicate that for the fragment the signal intensity is below or above the baseline intensity.

Accordingly, in some embodiments, the onset detection method includes determining the onset probability for one or more targeted fragments or utilizing those probabilities as explained and detailed below.

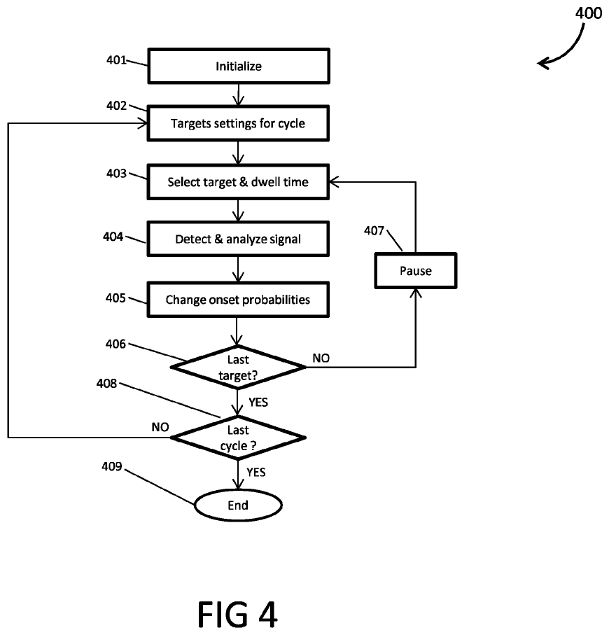

FIG. 4 shows a flow chart for an onset detection method 400 that includes utilizing the onset probabilities according to some embodiments. As an overview, method 400 includes a set of steps for a cycle operation (steps 402-408) that is performed for each cycle and is therefore repeated for the number of cycles in the system operation. Further, each cycle operation itself includes a set of steps for a target detection operation (steps 403-406) that is performed for detecting signals for each targeted fragment in the corresponding cycle and is therefore repeated for the number of targeted fragments in that cycle. In some embodiments, method 400 is performed by the controller module.

Regarding the details of method 400, at step 401 the controller module initializes the system for executing the cycles. More specifically, at this step, different parts of the system may be configured with appropriate settings for detecting an MRM. The settings may include, for example, the voltages in the precursor ion selection chamber or the fragment selection chamber, the pressure in the collision chamber, etc.

At step 402, the controller module starts the cycle operation for a new cycle by determining settings for the fragments targeted in that cycle (hereinafter called target settings for brevity). The target settings may include the set of the targeted fragments for that cycle and the dwell times for those fragments. The controller module may determine the set of targeted fragments, for example, as those for which the onset probability exceeds a threshold probability.

Alternatively, or in addition, at step 402, the controller module may allocate the dwell times to the targeted fragments based on their onset probabilities. For example, the dwell times may be proportional to the onset probabilities. Alternatively, or in addition, the controller module may allocate equal dwell times to all fragments for which the onset probability exceeds the threshold probability. In various embodiments, the threshold probability may have different values, such as 20%, 30%, 40%, 50%, 60%, etc.

In some embodiments, at step 402, the controller module may set the dwell time for a targeted fragment to an initial dwell time. The initial dwell time may have a low value equal to, for example, the onset detection dwell time. Alternatively, when the onset probability for a targeted fragment is high, for example, above a threshold probability, the controller may set the initial dwell time for that fragment to a high value, for example, equal or above the data collection dwell time.

In some embodiments, when the dwell time for a targeted fragment is already set, at step 402 the controller module may increase the dwell time. For example, if the controller module determines that, for a targeted fragment, the dwell time is set low, e.g., below the data collection value, but the onset probability is set above the threshold probability, the controller module may increase the dwell time to a value that is equal or above the data collection dwell time. The onset probability may have been set above the threshold probability at different stages such as at the end of the previous cycle, as further detailed below.

Alternatively, and in some embodiments, at step 402, the controller module may decrease a previously set dwell time. For example, if the controller module determines that, for a targeted fragment, the dwell time is set high, e.g., at or above the data collection value, but the onset probability is set below the threshold probability, the controller module may decrease the dwell time to a value that is below the data collection dwell time, for example, to the onset detection dwell time. In some embodiments, when the controller determines that a previously high onset probability has been reduced to below the threshold probability indicating that the generation of the targeted fragment has ended, the controller may set the dwell time for that fragment to zero or equivalently remove that fragment from the set of targeted fragments for the present cycle.

Next, at step 403, the controller module starts one round of the target detection operation (steps 403-406) in the cycle by selecting a member of the set of the targeted fragments for the corresponding cycle (i.e., in consecutive rounds sequentially advancing through the set of targeted fragments) and performs the detection operation for the selected targeted fragment (also called selected fragment for brevity).

Further, also at step 403, the controller module may pick the dwell time corresponding to the selected fragment as the duration of the target detection operation.

Moreover, the controller module may set the system settings to the fragment detection settings corresponding to the selected fragment.

At step 404, the system operates for the duration of the dwell time and, during that time, the detector detects the signal corresponding to the selected fragment and the analyzer module analyzes the detected signal. In some embodiments, before analyzing the signal, the analyzer module may remove from the detected signal one or more background signals. The resulting analyzed signal may be at different intensities, for example, weak (below the baseline) or strong (at or above the baseline). A weak signal may even have zero intensity or close to zero intensity.

In some embodiments, the intensity of the background signal may be determined as the average intensity of the background signal during a number of previous cycles. In some embodiments the number may be between 1 and 5.

At step 405, the analyzer module may analyze the signal and accordingly increase the onset probabilities for one or more of the targeted fragments based on detecting one or more indications that the onset may occur in the subsequent cycles. One such indication for a fragment may include an increase in the intensity of the signal corresponding to the fragment above a threshold intensity. In some embodiments, this threshold intensity may be between 1 cps and 1000 cps, and, for example, have values such as 5 cps, 10 cps, 20 cps, 50 cps, etc.

Another such indication may include a large value for the rate of change of the signal (measured as the difference between the intensities of the signal at the present and at the previous cycle, the difference being divided by the time difference between the two detections). In some embodiments, the probability is increased if the rate of change exceeds a threshold rate of change. In some embodiments, this threshold rate of change may be between 1 cps per cycle and 1000 cps per cycle, and, for example, have values such as 5 cps per cycle, 10 cps per cycle, 20 cps per cycle, 50 cps per cycle, etc.

Yet another indication may include detection of a family member for the fragment, etc. For example, if the system detects a fragment that corresponds to a compound (such as morphine), the analyzer module may increase the onset probability for a fragment that corresponds to a metabolite of that compound.

In some embodiments, at step 405, instead of or in addition to increasing the onset probabilities for some targeted fragments, the analyzer module may decrease the onset probabilities for one or more of the targeted fragments. The decrease may occur when, for example, the intensity of the signal for a fragment decreases below a minimum intensity threshold or the rate of change of the signal for a fragment becomes negative during one or more consecutive cycles. Alternatively, the analyzer module may decrease the onset probability for a fragment of a first compound after detecting the presence of a second compound which excludes the first compound. For example, in an embodiment in which the system generally searches for a set of candidate compounds that includes some vegetable pesticides and some animal hormones, if the system detects a vegetable pesticide in a sample, the analyzer module may conclude that the sample corresponds to vegetables and therefore exclude presence of the animal hormones in that sample.

In some embodiments, instead of changing the onset probability for a compound, the analyzer module may change the threshold value for the onset. For example, instead of increasing the onset probability for a compound, the analyzer module may decrease the threshold value for the onset probability for that compound to be used in the next cycle. Inversely, instead of decreasing the onset probability for a compound, the analyzer module may increase the threshold value for the onset probability for that compound to be used in the next cycle.

At decision step 406, the controller module ends the target detection operation for the selected target and determines whether or not the target detection operation has been performed for all members of the set of targeted fragments for the cycle.

If the answer at decision step 406 is no, the controller module proceeds to step 407 at which the controller module pauses the system for the duration of a pause time, and then circles back to step 403 to start the detection operation for the next member of the set of targeted fragments for the present cycle.

Alternatively, if the answer at decision a step 406 is yes, the controller proceeds to decision step 408, at which the controller module ends the cycle operation for the present cycle and determines whether or not all scheduled cycles have been completed.

If the answer at decision step 408 is no, the controller module circles back to step 402 to start the cycle operation for the next cycle.

Alternatively, if the answer at decision step 408 is yes, the controller module may proceed to step 409 to complete detection method 400.

The above discussed mechanisms may therefore be utilized to optimize the scheduling of the cycles and the assignment of the dwell times to different fragments for detecting various compounds.

In various embodiments, one or more of disclosed modules may be implemented via one or more computer programs for performing the functionality of the corresponding modules, or via computer processors executing those programs. In some embodiments, one or more of the disclosed modules may be implemented via one or more hardware units executing firmware for performing the functionality of the corresponding modules. In various embodiments, one or more of the disclosed modules may include storage media for storing data used by the module, or software or firmware programs executed by the module. In various embodiments, one or more of the disclosed modules or disclosed storage media may be internal or external to the disclosed systems. In some embodiments, one or more of the disclosed modules or storage media may be implemented via a computing “cloud,” to which the disclosed system connects via a network connection and accordingly uses the external module or storage medium. In some embodiments, the disclosed storage media for storing information may include non-transitory computer-readable media, such as a CD-ROM, a computer storage, e.g., a hard disk, or a flash memory. Further, in various embodiments, one or more of the storage media may be non-transitory computer-readable media that store data or computer programs executed by various modules, or implement various techniques or flow charts disclosed herein.

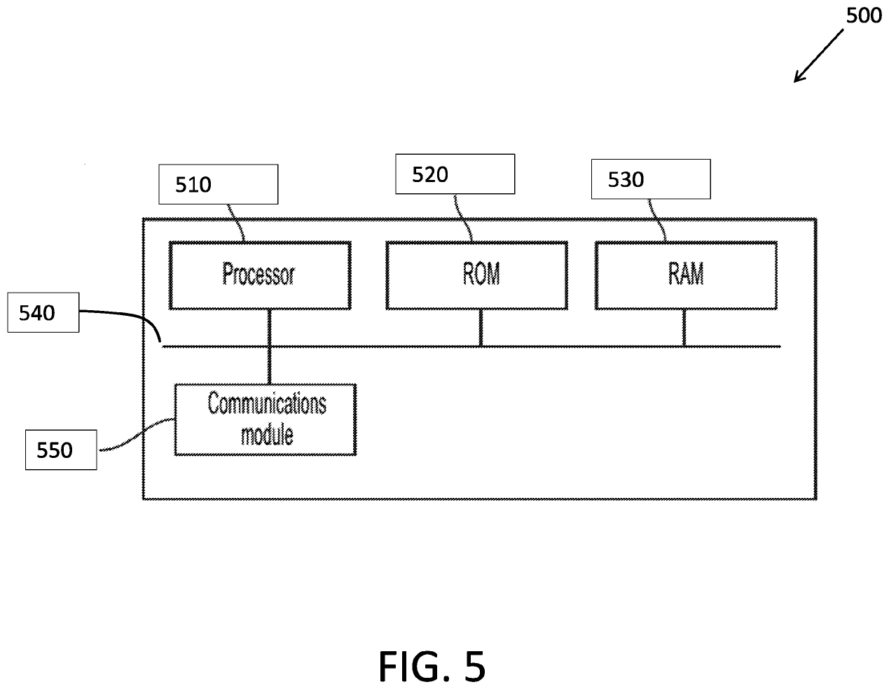

By way of example, FIG. 5 schematically depicts an example of an implementation of a module 500 according to some embodiments. Module 500 includes a processor 510 (e.g., a microprocessor), at least one permanent memory module (e.g., ROM 520), at least one transient memory module (e.g., RAM) 530, a bus 540, and a communication module 550.

Processor 510, ROM 520, and RAM 530 may be utilized to store and execute instructions performing the function of module 500. Moreover, bus 540 may allow communication between the processor and various other components of the controller. Communication module 550 may be configured to allow sending and receiving signals.

Although some aspects have been described in the context of a system and/or an apparatus, it is clear that these aspects may also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer, or an electronic circuit. In some embodiments, some one or more of the most important method steps may be executed by such an apparatus.

Those having ordinary skill will appreciate that various changes may be made to the above embodiments without departing from the scope of the invention.

The above detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments, and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

What is claimed is:

1. A method for analyzing a sample by mass spectrometry, the method comprising:
detecting a plurality of signals corresponding to a plurality of compounds in the sample;
performing an analysis of a signal of the plurality of signals corresponding to a compound of the plurality of compounds to detect an onset of an increase in the signal, wherein the analysis is different from comparing an intensity of the signal with a threshold; and
in response to detecting the onset, increasing a dwell time for the compound.

2. The method of claim 1, further comprising:
determining an onset probability as the probability of occurrence for the onset; and
utilizing the onset probability in detecting the onset.

3. The method of claim 2, wherein determining the onset probability utilizes information about a retention time for the compound.

4. The method of claim 2, wherein:
the compound is a first compound; and
determining the onset probability utilizes information about detecting a second compound that is related to the first compound.

5. The method of any claim 2, further comprising increasing the dwell time if the onset probability exceeds a threshold probability or decreasing the dwell time if the onset probability is below the threshold probability.

6. The method of claim 5, wherein decreasing the dwell time includes setting the dwell time to a zero value.

7. The method of claim 2, further comprising dividing a cycle time into a plurality of dwell times for a plurality of compounds proportional to a plurality of onset probabilities for the plurality of compounds.

8. The method of claim 1, wherein detecting the onset includes detecting a rate of change of the signal corresponding to the compound.

9. The method of claim 1, further comprising subtracting a background signal from the signal before performing the analysis.

10. The method of claim 1, further comprising increasing a pause time corresponding to the compound in response to detecting the onset.

11. The method of claim 10, further comprising setting the pause time to zero before detecting the onset.

12. The method of claim 1, wherein in response to detecting the onset, the dwell time for the compound is increased to a data collection value for collection of data corresponding to one or more fragments of the compound.

13. The method of claim 12, further comprising, before detecting the onset, setting the dwell time for the compound to a low value that is lower than the data collection value, wherein the low value enables generating the signal corresponding to the compound.

14. (canceled)

15. A method for analyzing a sample by mass spectrometry, the method comprising:
detecting a plurality of signals corresponding to a plurality of compounds in the sample;
performing an analysis of a signal of the plurality of signals corresponding to a compound of the plurality of compounds to detect an onset of an increase in the signal; and
in response to detecting the onset, increasing a pause time corresponding to the compound.

16. (canceled)

17. A mass spectrometry system comprising:
a detector configured to detect a plurality of signals corresponding to a plurality of compounds in a sample; and
an analyzer module configured to:
receive, from the detector, signal data corresponding to the plurality of signals;
perform an analysis of a signal of the plurality of signals corresponding to a compound of the plurality of compounds to detect an onset of an increase in the signal, wherein the analysis is different from comparing an intensity of the signal with a threshold; and
increase a dwell time for the compound in response to detecting the onset.

18. The system of claim 17, wherein the analyzer module is further configured to:
determine an onset probability as the probability of occurrence for the onset; and
utilize the onset probability in detecting the onset.

19. The system of claim 18, wherein the analyzer module is further configured to determine the onset probability by utilizing information about a retention time for the compound.

20. The system of claim 18, wherein the analyzer module is configured to increase the dwell time if the onset probability exceeds a threshold probability or decrease the dwell time if the onset probability is below a threshold probability.
